(19) United States
(12) Patent Application Publication
(10) Pub. No.: US 2024/0065919 A1
(43) Pub. Date: Feb. 29, 2024

(54) WALKING ASSISTANCE DEVICE

(71) Applicant: TOYOTA JIDOSHA KABUSHIKI KAISHA, Toyota-shi (JP)

(72) Inventors: Takumi MATSUO, Ichikawa-shi (JP); Tomoe AOKI, Chiba-shi (JP)

(73) Assignee: TOYOTA JIDOSHA KABUSHIKI KAISHA, Toyota-shi (JP)

(21) Appl. No.: 18/216,207

(22) Filed: Jun. 29, 2023

(30) Foreign Application Priority Data
Aug. 29, 2022 (JP) 2022-135537

(51) Int. Cl. A61H 3/00; A61H 1/02

(52) U.S. Cl. CPC A61H 3/00; A61H 1/0262; A61H 2003/007; A61H 2201/1261; A61H 2201/14; A61H 2201/1628; A61H 2201/164; A61H 2201/165; A61H 2201/1676

(57) ABSTRACT

The walking assistance device includes: a waist attachment portion attached to a waist; a left knee attachment portion attached to a left knee; and a stretchable left leg wire that connects the waist attachment portion and the left knee attachment portion and that extends along a front surface of a thigh. A motion of swinging the thigh forward is assisted by an elastic restoring force of the left leg wire. The waist attachment portion includes a wire guide extending along an outer periphery of the waist. The left leg wire extends from the left knee attachment portion toward the waist attachment portion, is guided by the wire guide and extends along the wire guide, and is selectively anchored to at least two or more anchoring portions separated from each other in a longitudinal direction of the wire guide.

### CROSS-REFERENCE TO RELATED APPLICATION

This application claims priority to Japanese Patent Application No. 2022-135537 filed on Aug. 29, 2022, incorporated herein by reference in its entirety.

### BACKGROUND

### 1. Technical Field

The present disclosure relates to a walking assistance device.

### 2. Description of Related Art

Japanese Patent No. 6889187 (JP 6889187 B) discloses a technique for assisting a motion of swinging a thigh forward by connecting a waist belt and a thigh brace with a flexible strap.

### SUMMARY

However, with the configuration of JP 6889187 B, it is difficult to adjust an assisting force that assists the motion of swinging the thigh forward.

An object of the present disclosure is to provide, with a simple configuration, a technique for adjusting an assisting force that assists an action of swinging a thigh forward.

According to an aspect of the present disclosure, provided is a walking assist device including: a waist attachment portion attached to a waist; a knee attachment portion attached to a knee; and a stretchable wire that connects the waist attachment portion and the knee attachment portion and that extends along a front surface of a thigh, in which the walking assistance device assists a motion of swinging the thigh forward by an elastic restoring force of the wire, in which the waist attachment portion includes a wire guide extending along an outer periphery of the waist, and in which the wire extends from the knee attachment portion toward the waist attachment portion, is guided by the wire guide and extends along the wire guide, and is selectively anchored to at least two or more anchoring portions separated from each other in a longitudinal direction of the wire guide. According to the above configuration, it is possible to adjust the assisting force that assists the motion of swinging the thigh forward with a simple configuration.

The at least two or more anchoring portions may be arranged on the front surface side of the waist. According to the above configuration, it is easy to anchor the wire to any one of the at least two or more anchoring portions.

The wire guide may include a guide back surface portion arranged on the back surface side of the waist, and the wire may extend through the guide back surface portion to reach the at least two or more anchoring portions. According to the above configuration, the total length of the wire can be gained.

An anchor thicker than the wire may be attached to the wire, and the wire may be anchored to one of the at least two or more anchoring portions via the anchor. According to the above configuration, the anchoring operation of the wire is facilitated.

A groove extending along the longitudinal direction of the wire guide is constituted in the wire guide, and at least a portion of the anchor may be accommodated in the groove when the anchor is anchored to one of the at least two or more anchoring portions. According to the above configuration, since the walking assistance equipment becomes thin, the walking assistance device can be made inconspicuous.

The wire guide may include a guide back surface portion arranged on a back surface side of the waist, and a pair of guide front surface portions arranged on a front surface side of the waist and adjacent to each other along the longitudinal direction of the waist attachment portion, and the guide front surface portions may be swingably attached to the guide back surface portion, and the guide front surface portions may be detachable from each other. According to the above configuration, by temporarily releasing the mutual connection between the pair of guide front surface portions, the wire guide can be easily attached to the waist.

According to the above disclosure, it is possible to adjust the assisting force that assists the motion of swinging the thigh forward with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view of a walking assistance device;

FIG. 2 is a plan view of a waist attachment portion;

FIG. 3 is a plan view of the waist attachment portion;

FIG. 4 is a front view of the waist attachment portion; and

FIG. 5 is an explanatory diagram of an operating mechanism of the walking assistance device.

### DETAILED DESCRIPTION OF EMBODIMENTS

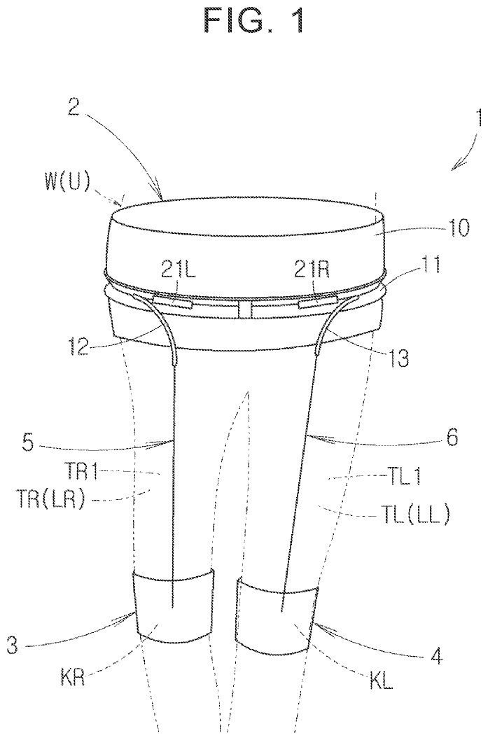

A preferred embodiment of the present disclosure will now be described with reference to FIGS. 1 to 5.

FIG. 1 shows a walking assistance device 1. The walking assistance device 1 is typically a device that assists swinging a thigh forward during walking. In addition, the walking assistance device 1 can assist the motion of swinging the thigh forward during running.

As shown in FIG. 1, the walking assistance device 1 includes a waist attachment portion 2, a right knee attachment portion 3, a left knee attachment portion 4, a right leg wire 5, and a left leg wire 6. The right knee attachment portion 3 and the left knee attachment portion 4 are specific examples of the knee attachment portion. The right leg wire and the left leg wire 6 are specific examples of wires. The right knee attachment portion 3 and the right leg wire 5 may be omitted when only the left leg is assisted, or the left knee attachment portion 4 and the left leg wire 6 may be omitted when only the right leg is assisted.

The waist attachment portion 2 is configured to be worn on a waist W of a user U.

The right knee attachment portion 3 is configured to be attached to the user's U right knee KR. The right leg wire 5 is a stretchable wire that connects the waist attachment portion 2 and the right knee attachment portion 3 and extends along a front surface TR1 of a thigh TR of the user's U right leg LR. An elastic restoring force of the right leg wire 5 assists the motion of swinging the thigh TR of the right leg LR of the user U forward.

Similarly, the left knee attachment portion 4 is configured to be attached to the user's U left knee KL. The left leg wire 6 is a stretchable wire that connects the waist attachment portion 2 and the left knee attachment portion 4 and extends along a front surface TL1 of a thigh TL of the user's U left leg LL. An elastic restoring force of the left leg wire 6 assists the motion of swinging the thigh TL of the left leg LL of the user U forward.

The waist attachment portion 2, the right knee attachment portion 3, the left knee attachment portion 4, the right leg wire 5, and the left leg wire 6 will be described in detail below.

Both the right leg wire 5 and the left leg wire 6 are made of a stretchable material. The stretchable material is typically a rubber cord.

The right knee attachment portion 3 is attachable to and detachable from the right knee KR so as not to interfere with the bending and stretching motion of the right knee KR. The right knee attachment portion 3 is typically made of cloth. The right knee attachment portion 3 is provided with, for example, a hook-and-loop fastener so that it can be easily attached to and detached from the right knee KR.

Similarly, the left knee attachment portion 4 is attachable to and detachable from the left knee KL so as not to interfere with the bending and stretching motion of the left knee KL. The left knee attachment portion 4 is typically made of cloth. The left knee attachment portion 4 can be easily attached to and detached from the left knee KL by being provided with, for example, a hook-and-loop fastener.

The waist attachment portion 2 includes a winding portion 10 that is wrapped around the waist W, a wire guide 11 that extends along the waist W, a right bending guide 12, and a left bending guide 13.

The winding portion 10 is typically made of cloth. The winding portion 10 can be easily attached to and detached from the waist W by being providing with a hook-and-loop fastener, for example.

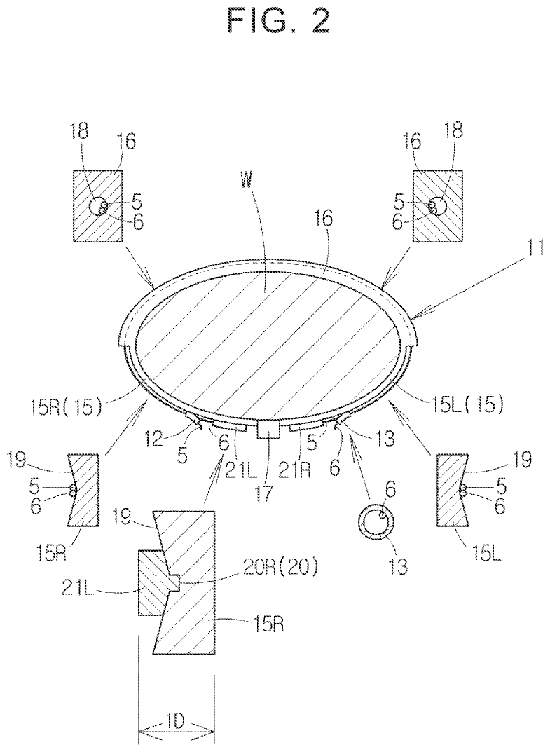

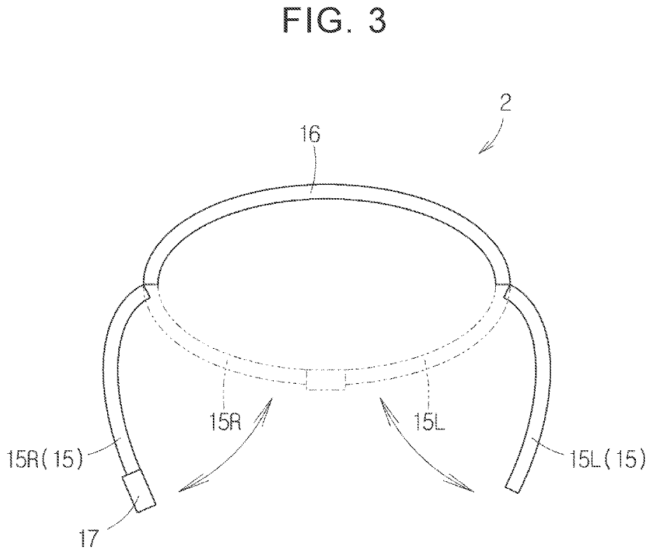

The wire guide 11 is supported by the winding portion 10 and has an annular shape in plan view. As shown in FIG. 2, the wire guide 11 includes a guide front surface portion 15 arranged on the front surface side of the waist W and a guide back surface portion 16 arranged on the back surface side of the waist W. The guide front surface portion includes a right guide front surface portion 15R on the right leg side and a left guide front surface portion 15L on the left leg side. As shown in FIG. 3, the right guide front surface portion 15R and the left guide front surface portion 15L are detachable from and attachable to each other via a connector 17 fixed to the right guide front surface portion 15R. The right guide front surface portion 15R is connected to the guide back surface portion 16 so as to be swingable. The left guide front surface portion 15L is connected to the guide back surface portion 16 so as to be swingable. The wire guide 11 is typically made of stainless steel or aluminum alloy.

Returning to FIG. 2, the guide back surface portion 16 includes a guide hole 18 through which the right leg wire 5 and the left leg wire 6 pass. The guide hole 18 is formed so as to extend along a longitudinal direction of the guide back surface portion 16.

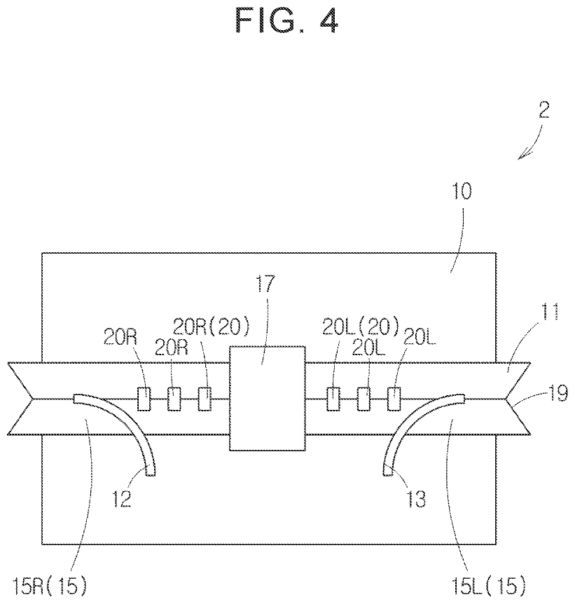

A guide groove 19 having a V-shaped cross section and opening in a direction away from the waist W is formed in the guide front surface portion 15. The guide groove 19 has a V-shaped cross section that opens outward. As shown in FIG. 4, a plurality of anchoring portions 20 is formed in the guide groove 19. The plurality of anchoring portions 20 is one example of at least two or more anchoring portions. Three anchoring portions 20R are formed on the right guide front surface portion 15R. Similarly, three anchoring portions 20L are formed on the left guide front surface portion 15L. The three anchoring portions 20R on the right guide front surface portion 15R are arranged apart from each other in the longitudinal direction of the wire guide 11. Similarly, the three anchoring portions 20L on the left guide front surface portion 15L are arranged apart from each other in the longitudinal direction of the wire guide 11. As shown in FIG. 2, each anchoring portion is formed at the deepest portion of the guide groove 19.

Returning to FIG. 1, the right bending guide 12 and the left bending guide 13 guide the right leg wire 5 and the left leg wire 6 to the wire guide 11, respectively. The right bending guide 12 and the left bending guide 13 are arranged on the front surface side of the waist W.

In this embodiment, the right bending guide 12 is a metal pipe, typically an aluminum alloy pipe that curves in an arc, and is supported by the wire guide 11. The right leg wire 5 extending along the front surface TR1 of the thigh TR of the right leg LR is smoothly curved by passing through the right bending guide 12 and guided to the guide groove 19 of the right guide front surface portion 15R of the wire guide 11.

Similarly, the left bending guide 13 is a metal pipe, typically an aluminum alloy pipe, which curves in an arc shape, and is supported by the wire guide 11. The left leg wire 6 extending along the front surface TL1 of the thigh TL of the left leg LL is smoothly curved by passing through the left bending guide 13 and guided to the guide groove 19 of the left guide front surface portion 15L of the wire guide 11.

The right bending guide 12 and the left bending guide 13 may be, for example, pulleys instead of being pipes curved in an arc.

With the above configuration, as shown in FIGS. 1 and 2, the right leg wire starts from the right knee attachment portion 3, extends along the front surface TR1 of the thigh TR of the right leg LR, and passes through the right bending guide 12 to be guided to the right guide front surface portion 15R of the wire guide 11. The right leg wire 5 passes through the guide groove 19 of the right guide front surface portion 15R and the guide hole 18 of the guide back surface portion 16 in this order, and reaches the guide groove 19 of the left guide front surface portion 15L. An anchor 21R that can be anchored to each anchoring portion 20 is attached to the tip of the right leg wire 5. The anchor 21R is thicker than the right leg wire 5. By anchoring the anchor 21R to one of a plurality of anchoring portions 20L disposed on the left guide front surface portion 15L as shown in FIG. 4, the right leg wire 5 connects the waist attachment portion 2 and the right knee attachment portion 3 to each other. By selectively anchoring the anchor 21R to any one of the plurality of anchoring portions 20L, an initial tension of the right leg wire 5 can be adjusted. For example, when the anchor 21R is anchored to the anchoring portion 20L closest to the connector 17 among the plurality of anchoring portions 20L shown in FIG. 4, the initial tension of the right leg wire 5 is increased. Conversely, when the anchor 21R is anchored to the anchoring portion 20L farthest from the connector 17 among the plurality of anchoring portions 20L, the initial tension of the right leg wire 5 is reduced.

Similarly, as shown in FIGS. 1 and 2, the left leg wire 6 starts from the left knee attachment portion 4, extends along the front surface TL1 of the thigh TL of the left leg LL, passes through the left bending guide 13 and is guided to the left guide front surface portion 15L of the wire guide 11. The left leg wire 6 passes through the guide groove 19 of the left guide front surface portion 15L and the guide hole 18 of the guide back surface portion 16 in this order, and reaches the guide groove 19 of the right guide front surface portion 15R. An anchor 21L that can be anchored to each anchoring portion 20 is attached to the tip of the left leg wire 6. The anchor 21L is thicker than the left leg wire 6. By anchoring the anchor 21L to one of a plurality of the anchoring portions 20R arranged on the right guide front surface portion 15R as shown in FIG. 4, the left leg wire 6 connects the waist attachment portion 2 and the left knee attachment portion 4 to each other. By selectively anchoring the anchor 21L to any one of the anchoring portions 20R, the initial tension of the left leg wire 6 can be adjusted. For example, when the anchor 21L is anchored to the anchoring portion 20R closest to the connector 17 among the anchoring portions 20R shown in FIG. 4, the initial tension of the left leg wire 6 is increased. In contrast, when the anchor 21L is anchored to the anchoring portion 20R that is farthest from the connector 17 among the anchoring portions 20R, the initial tension of the left leg wire 6 is reduced.

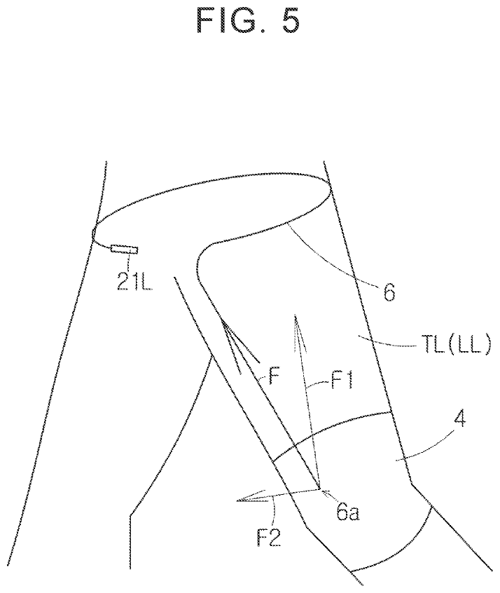

FIG. 5 shows how the elastic restoring force of the left leg wire 6 assists the motion of swinging the thigh TL of the left leg LL forward. As shown in FIG. 5, when the left leg LL is kicked backward in a stance phase of the left leg LL, the left leg wire 6 is stretched and an elastic restoring force F of the left leg wire 6 shown in FIG. 5 is generated. This elastic restoring force F consists of a component force F1 directed from an end portion 6a of the left leg wire 6 on the left knee attachment portion 4 side to a left hip joint, and a component force F2 directed forward from the end portion 6a (in the direction in which the free leg swings out). This component force F2 assists the motion of swinging the thigh TL of the left leg LL forward during a swing phase of the left leg LL. As described above, the walking assistance device 1 of the present embodiment is configured so that the initial tension of the left leg wire 6 can be adjusted and thus, the component force F2 (assist force) that assists swinging the thigh TL of the left leg LL forward can be adjusted.

For the same reason, the elastic restoring force of the right leg wire 5 assists the motion of swinging the thigh TR of the right leg LR forward. Since the walking assistance device 1 of the present embodiment is configured so that the initial tension of the right leg wire 5 can be adjusted, the component force F2 (assistance force) that assists swinging the thigh TR of the right leg LR forward can be adjusted.

The preferred embodiments of the present disclosure have been described above. The above-described embodiment has the following features.

That is, as shown in FIGS. 1 to 5, the walking assistance device 1 includes the waist attachment portion 2 attached to the waist W, the left knee attachment portion 4 (knee attachment portion) attached to the left knee KL, and the stretchable left leg wire 6 (wire) that connects the waist attachment portion 2 and the left knee attachment portion 4 and that extends along the front surface TL1 of the thigh TL. The motion of swinging the thigh TL forward is assisted by an elastic restoring force F of the left leg wire 6. The waist attachment portion 2 includes the wire guide 11 extending along the outer periphery of the waist W. The left leg wire 6 extends from the left knee attachment portion 4 toward the waist attachment portion 2, is guided by the wire guide 11 and extends along the wire guide 11, and is selectively anchored to at least two or more anchoring portions 20R separated from each other in the longitudinal direction of the wire guide 11. According to the above configuration, it is possible to adjust the component force F2 (assist force) that assists the motion of swinging the thigh TL forward with a simple configuration.

The walking assistance device 1 further includes the right knee attachment portion 3 and the right leg wire 5. For the same reason as above, it is possible to adjust the component force F2 (assisting force) that assists the motion of swinging the thigh TR forward with a simple configuration.

At least two or more anchoring portions 20 are arranged on the front surface side of the waist W. In this embodiment, the anchoring portions 20 are arranged on the guide front surface portion 15. According to the above configuration, the left leg wire 6 can be easily anchored to at least one of the two or more anchoring portions 20. This is because the anchoring operation can be visually observed.

The wire guide 11 also includes the guide back surface portion 16 that is arranged on the back surface side of the waist W. The left leg wire 6 extends through the guide back surface portion 16 to reach at least two or more anchoring portions 20. According to the above configuration, since the entire length of the left leg wire 6 can be gained, the durability of the left leg wire 6 can be improved.

The anchor 21L thicker than the left leg wire 6 is attached to the left leg wire 6. The left leg wire 6 is anchored to at least one of the two or more anchoring portions 20 via the anchor 21L. According to the above configuration, the anchoring operation of the left leg wire 6 is facilitated.

In addition, the anchoring structure of the anchor 21L and the anchoring portion 20 is arbitrary. The anchoring structure may be, for example, a structure in which the anchor 21L and each anchoring portion 20 are snap-fitted, or a structure in which the anchor 21L and each anchoring portion 20 are detachably/attachably connected with a hook-and-loop fastener.

Further, the wire guide 11 is formed with the guide groove 19 (groove) extending along the longitudinal direction of the wire guide 11. As shown in FIG. 2, when the anchor 21L is anchored to at least one of the two or more anchoring portions 20, at least part of the anchor 21L is accommodated in the guide groove 19. According to the above configuration, a total thickness 1D of the wire guide 11 and the anchor 21L is reduced. That is, since the walking assistance device 1 becomes thin, the walking assistance device 1 can be made inconspicuous.

Further, as shown in FIG. 3, the wire guide 11 includes the guide back surface portion 16 arranged on the back surface side of the waist W and the guide front surface portions 15 that are arranged on the front surface side of the waist W and that are adjacent to each other along the longitudinal direction of the waist attachment portion 2. The guide front surface portions 15 are attached to the guide back surface portion 16 so as to be swingable. The guide front surface portions 15 are detachable/attachable from each other. According to the above configuration, the wire guide 11 can be easily attached to the waist W by temporarily releasing the mutual connection between the guide front surface portions 15.

The right leg wire 5 is slidable with respect to the right bending guide 12. The right leg wire 5 is slidable with respect to the guide groove 19 of the guide front surface portion 15. The right leg wire 5 is slidable in the guide hole 18 of the guide back surface portion 16. Similarly, the left leg wire 6 is slidable with respect to the left bending guide 13. The left leg wire 6 is slidable in the guide groove 19 of the guide front surface portion 15. The left leg wire 6 is slidable with respect to the guide hole 18 of the guide back surface portion 16.

What is claimed is:

1. A walking assistance device comprising:
a waist attachment portion attached to a waist;
a knee attachment portion attached to a knee; and
a stretchable wire that connects the waist attachment portion and the knee attachment portion and that extends along a front surface of a thigh,
wherein the walking assistance device assists a motion of swinging the thigh forward by an elastic restoring force of the wire,
wherein the waist attachment portion includes a wire guide extending along an outer periphery of the waist, and
wherein the wire extends from the knee attachment portion toward the waist attachment portion, is guided by the wire guide and extends along the wire guide, and is selectively anchored to at least two or more anchoring portions separated from each other in a longitudinal direction of the wire guide.

2. The walking assistance device according to claim 1, wherein the at least two or more anchoring portions are arranged on a front surface side of the waist.

3. The walking assistance device according to claim 2,
wherein the wire guide includes a guide back surface portion arranged on a back surface side of the waist, and
wherein the wire extends through the guide back surface portion to reach the at least two or more anchoring portions.

4. The walking assistance device according to claim 1,
wherein an anchor thicker than the wire is attached to the wire, and
wherein the wire is anchored to one of the at least two or more anchoring portions via the anchor.

5. The walking assistance device according to claim 4,
wherein a groove extending along the longitudinal direction of the wire guide is constituted in the wire guide, and
wherein at least part of the anchor is accommodated in the groove when the anchor is anchored to one of the at least two or more anchoring portions.

6. The walking assistance device according to claim 1,
wherein the wire guide includes a guide back surface portion arranged on a back surface side of the waist, and a pair of guide front surface portions arranged on a front surface side of the waist and adjacent to each other along the longitudinal direction of the waist attachment portion, and
wherein the guide front surface portions are swingably attached to the guide back surface portion, and
wherein the guide front surface portions are detachable from each other.
